(19) United States
(12) Patent Application Publication
(10) Pub. No.: US 2018/0081972 A1
(43) Pub. Date: Mar. 22, 2018

(54) FILTERING AND PROCESSING DATA RELATED TO INTERNET OF THINGS

(71) Applicant: SAP SE, Walldorf (DE)

(72) Inventors: Ramana Mohanbabu, Bangalore (IN); Abhinav Kumar, Bangalore (IN); Vikas Rohatgi, Banglore (IN); Aarti Bijlani, Bangalore (IN)

(21) Appl. No.: 15/268,647

(22) Filed: Sep. 19, 2016

(51) Int. Cl. G06F 17/30; H04L 29/06

(52) U.S. Cl. CPC G06F 17/30867; H04W 4/005; H04L 63/0876

(57) ABSTRACT

Various embodiments of systems and methods for filtering and processing data related to internet of things are described herein. The method includes reading data from a sensor coupled to a device. The sensor collects data in real time. The read data is correlated within the device based upon a time the data is collected by the sensor. One or more predefined events are evaluated on the correlated data within the device. An output including the correlated data satisfying the condition specified in the one or more predefined events is generated by the device. The generated output is stored within the device, sent to cloud or a server for further storage and analysis, used for controlling actuations of one or more actuators, and is used for initiating a workflow for starting one or more repair actions for the device.

### BACKGROUND

Internet of Things (IoT) is a network of physical objects, machines, or devices (i.e., “things”) communicatively connected to collect, analyze, and/or exchange data with users and/or between each other. The collected data is sent to cloud or a central server for storage and further analysis. Usually, the data collected is voluminous and includes various undesired data or noise. Storing the voluminous or undesired data in cloud or server unnecessarily consumes large memory and is therefore, costly. Filtering the voluminous undesired data at server is also a time consuming task and decreases processing speed. Moreover, there might be latency in transferring data to the server, e.g., due to internet connectivity issues and/or server issues (e.g., heavy load on the server, server down, etc.), and therefore, it might not be possible to perform real-time data filtering and analysis. Due to this latency, predictive maintenance or analysis may also not be performed on time. Also, data filtering or processing rules are hardcoded within a cloud application and modifying these filtering or processing rules may be cumbersome and time consuming.

### BRIEF DESCRIPTION OF THE DRAWINGS

The embodiments are illustrated by way of examples and not by way of limitation in the figures of the accompanying drawings in which like references indicate similar elements. The embodiments may be best understood from the following detailed description taken in conjunction with the accompanying drawings.

FIG. 1 is a block diagram illustrating various components for filtering and processing data related to an internet of things (IoT) device, according to an embodiment.

FIG. 2 is a block diagram illustrating sensor reader for reading data collected by a sensor coupled to the IoT device and data correlator for correlating the read data, according to an embodiment.

FIG. 3 is a block diagram illustrating rule invoker for invoking a rule engine of the IoT device for evaluating events on the correlated data, according to an embodiment.

FIG. 4 is a block diagram illustrating actuator controller to control actuator and/or trigger workflow based on an output generated by the rule engine and a sensor coupled to the IoT device and including an application to analyze the output generated by the rule engine, according to an embodiment.

FIG. 5 is a flowchart illustrating a process of filtering and processing data related to Internet of Things (IoT), according to an embodiment.

FIG. 6 is a block diagram illustrating an exemplary computer system, according to an embodiment.

### DESCRIPTION

Embodiments of techniques for filtering and processing IoT data described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

“Internet of Things” or IoT refers to a network of devices or “things” connected to collect and/or exchange data with users, servers, other connected devices, and/or cloud. The IoT enables transfer or exchange of data over a network without requiring human-to-human interaction. Data is created or collected by a device. The data may be created or collected through one or more sensors communicatively coupled to the device. For example, a thermometer (sensor) may collect engine temperature (data) of an automobile. Amount of data collected through sensors in IoT network is voluminous. The data may be time-stamped (e.g., time series data) and/or geo location stamped data.

“Device” or “Thing” refers to a logical and/or a physical unit adapted for a specific purpose. For example, a device may be at least one of a mechanical and/or an electronic unit. The device may include any real world object or things required to be analyzed, observed, or monitored. Device encompasses, but is not limited to, a communication device, a computing device, a handheld device, and a mobile device such as an enterprise digital assistant (EDA), a personal digital assistant (PDA), a tablet computer, a smartphone, a vehicle, a machine, an engine, a smart device, for example smart watches or glasses, and the like. A device can perform one or more tasks. The device includes computing system comprising electronics (e.g., sensors) and software. The device is uniquely identifiable through its computing system. The device can access internet services such as World Wide Web (www) or electronic mails (E-mails), and exchange information with another device or a server by using wired or wireless communication technologies, such as Bluetooth, Wi-Fi, Universal Serial Bus (USB), infrared and the like. A device used in IoT network may be termed as an IoT device, however, the term “device” and “IoT device” may be used interchangeably.

“Parameter” or “dimension” refers to a measurable feature of a device such as temperature, speed, vibration, pressure, moisture content of the device, etc.

“Data” refers to a value of a parameter of the device. For example, the data may be a value (e.g., 500 ° F.) of a temperature (parameter) of a device (engine). The data or values of parameters may be measured through one or more sensors coupled to the device, e.g., a barometer, a thermometer, a force sensing resistors, etc. Values of different parameters may be collected or measured through different sensors. For example, the value (data) of temperature (parameter) of an engine (device) may be measured by an infrared or IR thermometer (sensor). The data is collected by the sensor continuously in real time.

“Correlated data” refers to data of different parameters which are related to each other based on some criteria, e.g., time. The data of different parameters may be correlated with respect to same point of time, different point of time, or other common parameter. For example, temperature data and vibration data collected at same point of time (5 PM), the temperature data collected at time T1 and vibration data collected at time T2, or the temperature data and vibration data collected when pressure is 101325 pascal. The data (e.g., temperature value and vibration value) may be correlated continuously or at a predefined time interval. The correlated data may also include time stamp indicating the time at which the correlated data is collected. The time stamp may be in any suitable format. For example, the time stamp may include the date, hour, minutes, and seconds at which the correlated data is collected such as if the correlated data is collected on 29 Nov. 2015 at 12 PM, the time stamp may be of format 29.11.2015:12 PM.

“Event” refers to an occurrence of a condition. For example, the occurrence of a condition: “when the temperature of a device is more than 50° C.” is an event. The condition may also be formed by a combination of one or more constraints on values of one or more parameters. For example, a condition including a combination of constraints may be “when the temperature of the device is above 550° C. and the vibration of the device is 1900 RPM (revolution per minute).” The occurrence of these conditions trigger events. An event can be of various types, e.g., a failure event (i.e., a condition indicating failure of a device), a historical event (i.e., a condition indicating or capturing data related to the device for last 1 day). Based upon the occurrence of the event, certain action (e.g., remedial actions) can be triggered. For example, an alarm (e.g., sound or light) can be triggered and/or an inspection or repair workflow may be initiated. The remedial actions may help to perform predictive maintenance, improve a design of a device, avoid accidents, etc. The desired event may be defined or configured by users, based upon their requirement. For example, if a user wants to be notified “when the temperature of the device is above predefined threshold (e.g., 550° C.)”, the event may be configured as “raise an alarm when the temperature of the device is above 550° C.” The user may want to analyze and collect data related to the configured event.

“Noise” refers to undesired or unwanted data. User can define or configure the desired data, e.g., by defining condition for capturing data (i.e., the events), and the remaining unwanted data may be filtered as noise. For example, if a user is interested in capturing a speed of a device when the temperature of the device is more than 50° C., then the speed of the device at temperature less than or equal to 50° C. becomes unwanted data or noise. The data collected by the device (e.g., through its sensors) may be analyzed upon filtering the noise. The noise can be filtered or determined at the device itself. An event or a set of events may be defined for determining or filtering the noise. The determined noise may be deleted, e.g., instantaneously or at a predefine time interval. The data (i.e., excluding noise) may be stored in the device and/or sent to the cloud or server for storage and analysis.

“Data repository” refers to a storage comprising: one or more database tables storing data related to the devices; one or more data models generated for data; one or more “visualizations” generated from the stored data; and one or more “patterns” predefined for devices.

“In-memory” database refers to a database that relies on main memory for computer data storage. In some examples, the in-memory database includes a combination of main memory and disk storage. Also, the in-memory database may support real-time analytics and transactional processing including replication and aggregation techniques. Also, within the in-memory database environment, calculation logic is pushed down into the database layer (as opposed to residing in the application layer) such that the processing time for querying and manipulating the data within the database may be reduced as compared to conventional relational database. In some examples, the in-memory database may be SAP HANA® Enterprise 1.0 (or any other versions). However, the techniques described herein may be applied to any type of relational database as well.

“Application” refers to a software or a set of computer programs that are executed to perform various functions. For example, an application may be executed to measure productivity, perform predictive maintenance, and generate report based upon historical data, etc. The application may be interactive, i.e., have a graphical user interface through which a user can query, modify, and input data and also analyze results instantaneously. The application hosted on cloud may be termed as “cloud application.” The “cloud application” helps a user to query, modify, and analyze the collected or stored data.

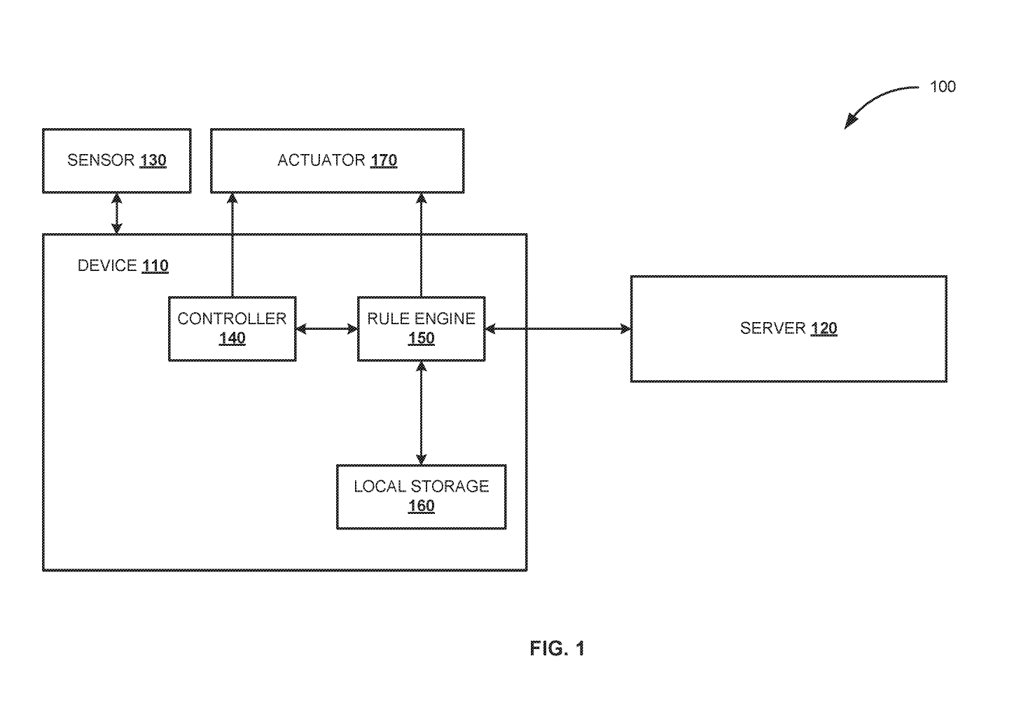

FIG. 1 is a block diagram illustrating exemplary system 100 for filtering and processing data related to Internet of Things (IoT), according to an embodiment. The system 100 comprises device 110 for receiving data, filtering noise from the received data, and sending the filtered data to a cloud or server 120 for storage and/or further analysis. The device 110 includes one or more sensors, e.g., sensor 130. In an embodiment, the sensor 130 may be a part of the device. In an embodiment, the sensor 130 may be a separate unit communicatively coupled to the device 110. The sensor 130 collects data. The data may be values of parameters related to the device 110. For example, the data may be value of at least one of the parameters namely temperature, speed, pressure, vibration, moisture content, etc., of the device 110. The data may be read by the device 110 and sent to controller 140 within the device 110. The read sensor data is correlated (e.g., by the controller 140). Data correlation refers to establishing relationship between data of different parameters, e.g., based on time. The data may be correlated by collecting and/or storing data of different parameters collected at same point in time by the one or more sensors. For example, if the sensor 130 collects temperature data at 10 PM, 11 PM, 12 PM, and 13 PM as 30° C., 40° C., 50° C., and 80° C. and vibration data at 10 PM, 11 PM, 12 PM, and 13 PM as 1800 RPM, 1805 RPM, 1900 RPM, and 1900 RPM, respectively, then temperature data and vibration data may be correlated based upon time, e.g., the temperature and vibration data collected at 12 PM (i.e., 50° C. and 1900 RPM) may be correlated data. Therefore, when temperature measured by the sensor is 50° C. the corresponding vibration measured, at same time, is 1900 RPM and then 50° C. and 1900 RPM are correlated data. In an embodiment, the data may be correlated, e.g., using correlation algorithm, within a component positioned outside the controller 140. In an embodiment, the data may be correlated within the controller 140. The correlated data is sent to rule engine 150. In an embodiment, the correlated data is generated with a time stamp, i.e., the time at which the data is collected by the sensor 130.

The rule engine 150 reads the correlated data (along with time stamp) to determine if any of the correlated data satisfies condition specified in a predefined event. For example, the predefined event may be: “trigger an alarm when the temperature is greater than 50° C. and the vibration is greater than 1800 RPM”. The predefined event may be stored in the rule engine 150. The rule engine 150 evaluates the predefined event on the correlated data read by the rule engine 150 to determine if any of the correlated data satisfies the constraints specified in the predefined event. For example, it may be determined that the correlated data (80° C., 1900 RPM) satisfies the constraints specified in the event. Once the condition is satisfied, the rule engine 150 generates an output. In an embodiment, the output refers to the event satisfied with the values of correlated data which satisfied the condition specified in the event. In an embodiment, the output also includes the time stamp at which the correlated data is collected. For example, the output may be “trigger an alarm: temperature 80° C.: vibration 1900: time stamp (data collected at): 29.11.15:12 PM.” The output may be stored locally in the device 110, e.g., in local storage 160. In an embodiment, based upon the output, one or more actuators (e.g., alarm, light, etc.) may be controlled, and/or a workflow (e.g., specified in the event/output) may be triggered to initiate the repair or remedial action. For example, actuator 170 may be controlled based upon the output. In an embodiment, the controller 140 controls the actuator 170 based upon the output generated from the rule engine 150. The output may also be sent to the cloud server or server 120 for storage and/or further analysis. In an embodiment, if there is connectivity issues or if server 120 is overloaded or down, the output stored in the local storage 160 may be transferred later to the server 120 once the connection is established. In an embodiment, once the output is transferred or sent to the server 120, the output stored in the local storage 160 of the device 110 may be deleted.

The device 110 may include any real world object or things required to be analyzed, observed, or monitored. For example, the device 110 may be a car, a machine, etc., which may be monitored for predictive maintenance or to pre-detect failure or critical condition. The devices 110 may be monitored by analyzing values of its parameters such as temperature, speed, vibration, etc. For example, a rotating machine may have a predefined or pre-set vibration frequency which might increases with time or age and required to be monitored. There may be predefined constraints (e.g., based upon parameters' values) for normal operation of the device 110 (e.g., a machine). Based upon the predefined constraints, a monitoring condition may be defined to monitor the machine. For example, the monitoring condition for the machine indicating it's normal working condition (e.g., in terms of its temperature and vibration) may be defined as shown below:

| TEMPERATURE (° C.) | VIBRATION (RPM) |
|---|---|
| 60-70 | 1800 |
| 70-80 | 1850 |
| 80-85 | 1900 |

The monitoring condition indicates that when the temperature of the machine is between 60° C.-70° C., the vibration should be 1800 RPM, when temperature of the machine is between 70° C. -80° C., the vibration should be 1850 RPM, and when the temperature of the machine is between 80° C.-85° C., the vibration should be 1900 RPM. In case of deviation of correlation of temperature and vibration, the possible failure can be predicted. If the machine's temperature and vibration does not match above specifications, there may be high possibility of failure.

When the parameters values deviates it might indicate abnormal condition of the machine and requirement for maintenance or repair. There may be plurality of devices which are analyzed or monitored. Each device (e.g., the device 110) may have a unique identifier (ID). For example, the device 110 may have an ID 001. The device 110 may be coupled with one or more sensors for collecting data related to one or more parameters of the device 110. In an embodiment, there may be one sensor collecting data related to a plurality of parameters. In an embodiment, there may be separate sensors for collecting data related to different parameters. The data collected by the sensor (e.g., the sensor 130) is read by a sensor reader.

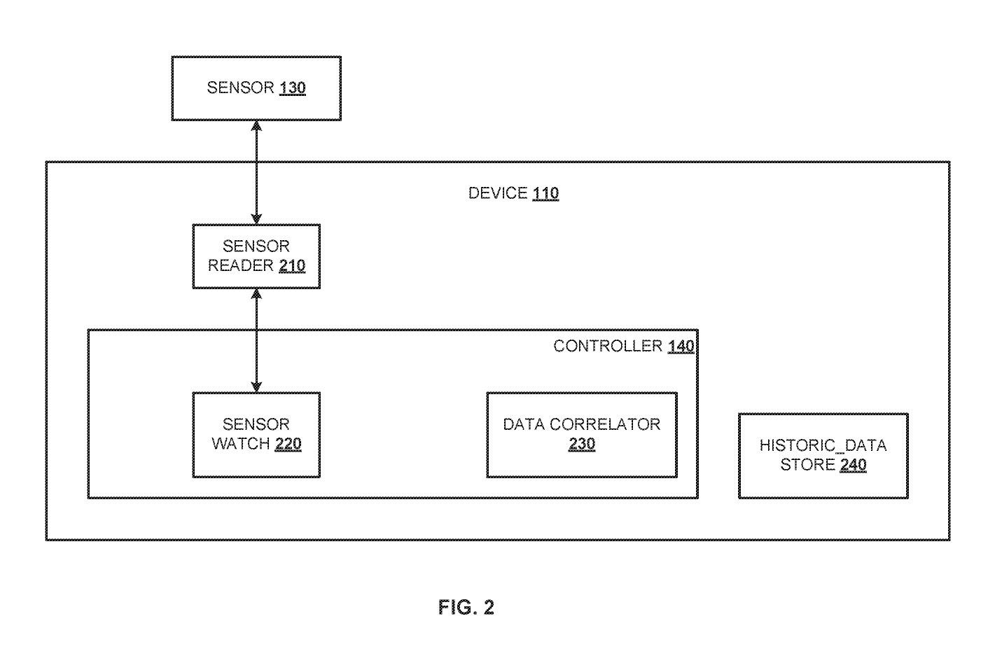

FIG. 2 is a block diagram illustrating sensor reader 210 for reading the data collected by one or more sensors, e.g., the sensor 130. The sensor reader 210 may be positioned or integrated within the device 110 or may be a separate unit communicatively coupled to the device 110. In an embodiment, the sensor reader 210 may be a part of the controller 140. The sensor reader 210 may read the data from the sensor 130 continuously or at a predefined time interval. Sensor watch 220 schedule a regular read (e.g., at a predefined time interval or continuously) of the data through the sensor reader 210. In an embodiment, the sensor watch 220 may be a part of the controller 140.

The data read by the sensor reader 210 is sent to data correlator 230. In an embodiment, the data correlator may be positioned within the controller 140. In an embodiment, the data correlator may be a separate unit communicatively coupled to the controller 140. The data correlator 230 correlates different data read by the sensor reader 210 (e.g., temperature value and vibration value). For example, if the sensor reader 210 read temperature data as 30° C., 40° C., 50° C., and 80° C. and vibration data as 1800 RPM, 1805 RPM, 1900 RPM, and 1900 RPM, then temperature data and vibration data may be correlated by the data correlator 230. The data may be correlated based on time, e.g., temperature data 50° C. and vibration data 1900 RPM collected at 12 PM may be correlated based on time (i.e., 12 PM). Therefore, when temperature was 50° C, the corresponding vibration was 1900 RPM and (50° C. and 1900 RPM) are correlated data. The correlated data may also include time stamp indicating the time at which the correlated data is collected by the sensor 130. The time stamp may be in any suitable format. In an embodiment, the time stamp may include the date, hour, minutes, and seconds at which the correlated data is collected by the sensor 130. For example, if the correlated data (temperature value and vibration value) is collected on 29 Nov. 2015 at 12 PM, the time stamp may be of format 29,11.2015:12 PM. In an exemplarily embodiment, the correlated data may be as shown in TABLE_1:

TABLE_1

| TEMPERATURE (° C.) | VIBRATION (RPM) | TIME STAMP |
|---|---|---|
| 30 | 1800 | 29.11.2015:9 PM |
| 40 | 1805 | 29.11.2015:10 PM |
| 50 | 1900 | 29.11.2015:11 PM |
| 80 | 1900 | 29.11.2015:12 PM |

In an embodiment, the correlated data may be transferred and stored in historic_data store 240. The historic_data store 240 may be a part of the device 110. In an embodiment, the historic_data store 240 may be a part of the local storage 160 (FIG. 1) of the device 110. The stored correlated data may be fetched or retrieved when required from the historic_data store 240. In an embodiment, the correlated data stored in the historic_data store 240 may be used by the data correlator 230 for correlating data based on earlier stored or historic data. For example, the data correlator 230 may require historic or earlier stored data, e.g., temperature in last 60 minutes, from the historic_data store 240 to determine or correlate average temperature in last 60 minutes with frequency of the device 130. In an embodiment, the stored correlated data may be deleted at a predefined time interval from the historic_data store 240. The correlated data may be sent to the rule engine 150 (FIG. 1) to determine if any of the correlated data satisfy predefined events or rules.

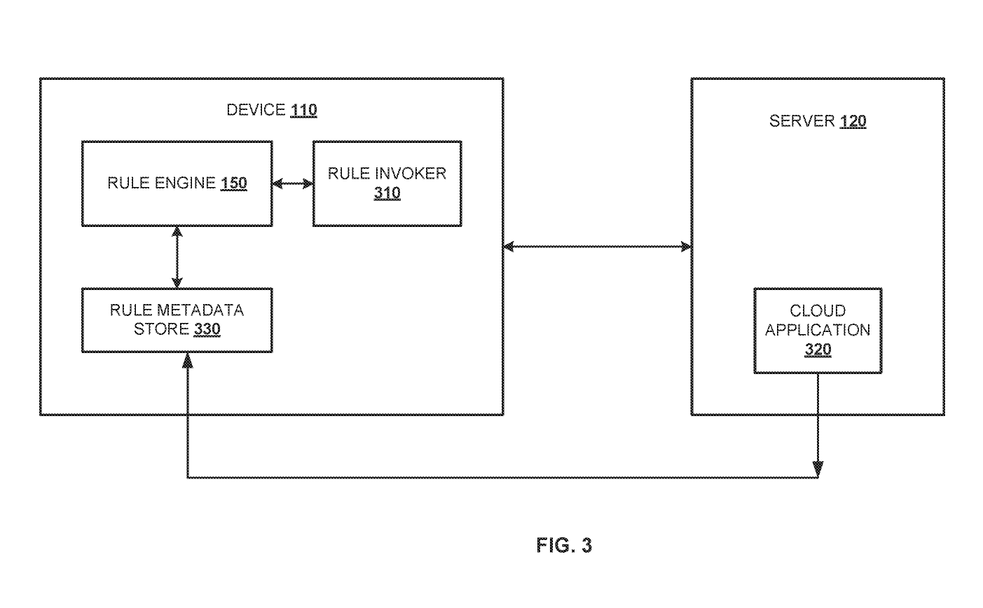

FIG. 3 is a block diagram illustrating rule engine 150 in communication with rule invoker 310. The rule engine 150 may be invoked or triggered by the rule invoker 310. Once the rule engine 150 is invoked, the rule engine 150 reads the correlated data to determine if any of the correlated data satisfies or meets predefined event condition. The event may be predefined and stored in the rule engine 150. The event or rule may be defined based upon the values of the one or more parameters of the device 110. For example, based upon the values of the temperature and vibration of the device 110, the event may be defined as: “trigger an alarm when the temperature is greater than 50° C. and the vibration is greater than 1800 RPM”. In an embodiment, the event may be defined based upon values provided in the monitoring condition of the device. For example, if normal monitoring condition is defined as “when the temperature of the machine is between 60° C.-70° C., the vibration should be 1800 RPM” then the event may be defined as “when the temperature of the machine is between 60° C. and 70° C. and vibration 1-1800 RPM, raise an alarm.”

In an embodiment, the events or rules may be easily configured, changed, reconfigured, or defined through cloud or server 120 (FIG. 1), e.g., using cloud application 320. The cloud application 320 can be accessed globally through any device, therefore, the rules or events can be easily configured through any device. In an embodiment, the rules can be directly configured or changed at the device 110 itself. The cloud application 320 includes one or more UIs for configuring the rules or events. The UI for configuring rules or constraints may be visualized as table in if-then style, as shown below:

| TEMPERATURE | VIBRATION | RAISE | START |
|---|---|---|---|
| (° C.) | (RPM) | ALARM | WORKFLOW |
| 60-70 | >1800 | TRUE | START WF_TYPE 1 |
| 70-80 | >1850 | TRUE | START WF_TYPE 2 |
| 80-85 | >1900 | TRUE | START WF_TYPE 3 |
| >85 | * | TRUE | START WF_TYPE 4 |

The users can enter the values of parameters in the UI or table to configure the events or rules. Therefore, there is no need for specific skill set for configuring or hardcoding the event. In an embodiment, authorized users can access the UI to define or configure the events or rules. The above events indicate that when the temperature of the machine is between 60° C.-70° C. and vibration is greater than 1800 RPM, an alarm is raised or triggered and workflow of TYPE 1 is initiated or started (i.e., START WF_TYPE 1), when the temperature of the machine is between 70° C. -80° C. and vibration is greater than 1850 RPM, the alarm is raised and the workflow of TYPE 2 is initiated, when the temperature of the machine is between 80° C. -85° C. and vibration is greater than 1900 RPM, the alarm is raised and the workflow of TYPE 3 is initiated, and when the temperature of the machine is greater than 85° C. at any vibration, the alarm is raised and the workflow of TYPE 4 is initiated.

In an embodiment, the rules may be hardcoded, e.g., as “if the current RPM is 1800 and average temperature is not between 60° C.-70° C. in last 30 minutes then: Trigger the alarm, trigger a workflow for machine repair, and log the temperature and vibration values in cloud for last 1 day.” The configured rules or events may be deployed and stored in the device 110 (e.g., within the rule engine 150 of the device 110). In an embodiment, the events or rules are deployed to the device, e.g., using a command: deploy Event_1 to the device 110 (ID: 001). In an embodiment, the rules may be pushed or deployed through a connection protocol or a web socket (e.g., TCPIP socket). The web socket communicatively couples the device 110 and an IoT services component (not shown) of the server 120. The IoT services component deploys the rules or events from the server 120 to the device 110. The rules may be deployed to the rule engine 150 of the device 110. In an embodiment, the device 110 includes rule metadata store 330. The rule metadata store 330 stores the metadata of the rules or events deployed within the rule engine 150 of the device 110. In an embodiment, the device 110 authorizes the server/cloud before deploying the rules or events from the server.

The stored or preconfigured rules or events are executed by the rule engine 150 of the device 110. Therefore, based upon the configured rules, constraints, or events, the device 110 can be monitored or analyzed, e.g., in real time. The rule engine 150 reads the correlated data and determines if any of the correlated data meets condition specified in the predefined event. The rule engine 150 actually evaluates the predefined rules on the correlated data to determine if any of the read correlated data meets the constraints specified in the predefined event. For example, it may be determined that the correlated data (temperature: 80, vibration: 1900) meets the constraints specified in the event. Once the condition specified in the event is met, the rile engine 150 generates an output.

The output includes the event satisfied with the values of correlated data which satisfied the condition specified in the event. For example, the output may be “trigger an alarm as temperature is 80° C. and vibration is 1900.” The output may be in a tabular format, e.g., as shown below:

| TEMPERATURE (° C.) | VIBRATION (RPM) | ALARM |
|---|---|---|
| 80 | 1900 | TRIGGER/YES |

The output may also include the time stamp and the ID of the device for which the event is triggered. For example, the output including the time stamp and the device ID may be as shown below:

| | | | VIBRA- | |
|---|---|---|---|---|
| DEVICE | | TEMPERATURE | TION | |
| ID | TIME STAMP | (° C.) | (RPM) | ALARM |
| 001 | 29.11.2015:12 PM | 80 | 1900 | TRIGGER |

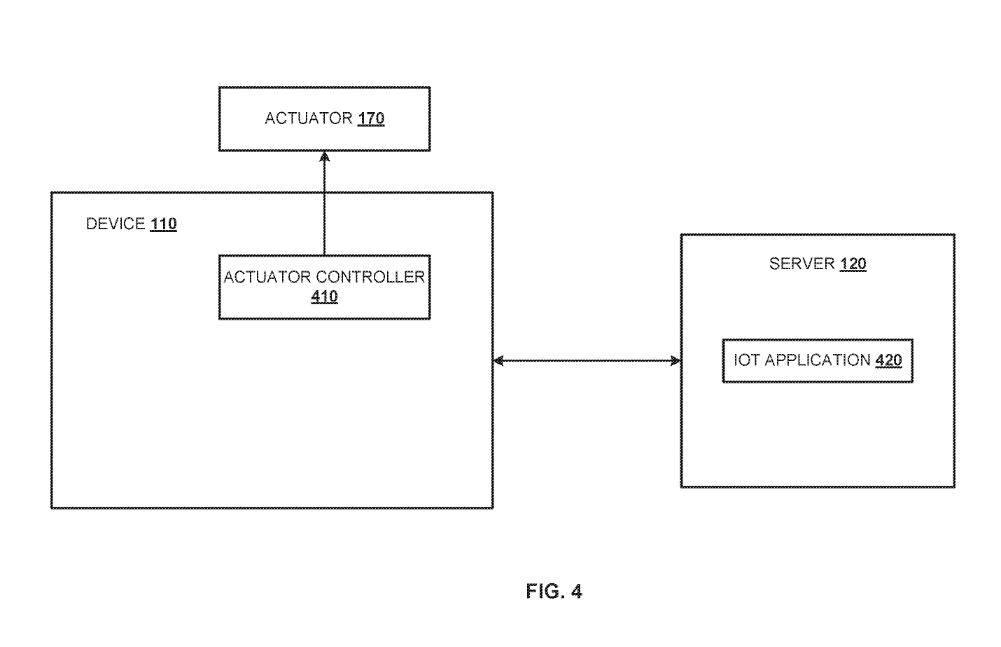

The output may be stored locally in the device 110. The output may be stored in a separate rule output store (not shown) coupled to the device 110. Based upon the output, remedial action(s) may be initiated to prevent accidents, damage or failure of the device, and/or improve device performance or design. In an embodiment, the output may be sent to actuator controller 410 (FIG. 4) which controls actuations based upon the received output. For example, the actuator controller 410 may control actuations (blow alarm or switch ON light) of actuators (alarm, light, etc.) such as actuator 170, based on the received output. The actuator 170 (alarm, light, etc.) may be communicatively coupled to the device 110. In an embodiment, the actuator controller 410 may also trigger a workflow (e.g., specified in the event or output) to initiate remedial action. The output may be sent to the cloud or server 120 for storage and/or further analysis. In an embodiment, if there is connectivity issues or if the server 120 is overloaded or down, the output stored in the rule output store of the device 110 may be transferred later to the server 120 once the connection is established. In an embodiment, once the output is transferred or sent to the server 120, the output stored in the rule output store may be deleted. The output (events) required for historical analysis, e.g., sensors values for last 1 day, can be assembled as tuple (rows) and transferred or pushed to the cloud or server 120. The server 120 may store the received output. In an embodiment, IoT application 420 installed within the server 120 may be used to analyze the received output. The IoT application 420 may be analytical application running on cloud.

In an embodiment, the server 120 also includes a decision management service component (not shown) to identify the parameters related to the device 110, e.g., temperature, pressure, vibration, etc., and provide the parameters related to the device 110 to an engine which generates UI for defining rules or events.

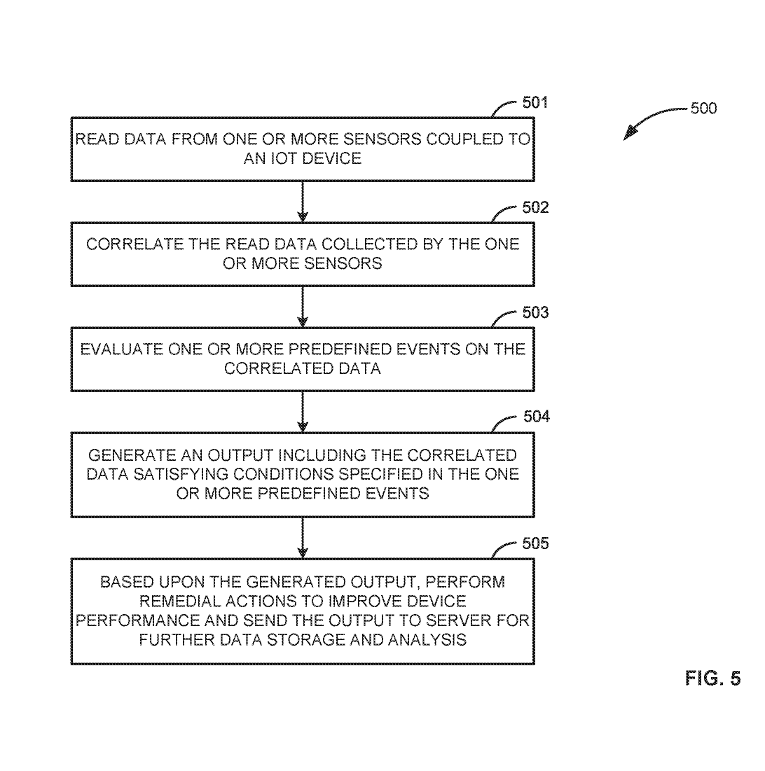

FIG. 5 is a flowchart illustrating process 500 to filter and process data related to internet of things (IoT) at IoT device (e.g., the device 110 of FIG. 1), according to an embodiment. At 501, data from one or more sensors coupled to a device is read. The data refers to values of one or more parameters related to the device, e.g., value of temperature, vibration, pressure, speed, moisture content, etc., of the device. The data is collected by the one or more sensors in real time. The data collected by the one or more sensors is read continuously or at a predefined time interval. At 502, the read data is correlated within the device. In an embodiment, the data is correlated based upon a time. In an embodiment, correlating the read data refers to storing together the data of different parameters collected in same point of time by the one or more sensors. For example, the value of temperature and vibration collected at 5 PM by the sensor. At 503, one or more predefined events are evaluated on the correlated data within the device. Evaluating the one or more predefined events on the correlated data refers to determining if any of the correlated data meets or satisfies the constraints or conditions specified in the one or more predefined events. At 504, upon determining that at least one of the correlated data satisfies the condition specified in the event, an output is generated by the device. The output includes the correlated data which satisfied the condition specified in the one or more predefined events. In an embodiment, the output also includes an identifier of the IoT device for which the event is triggered and a time stamp indicating a time at which the one or more predefined events occurred. In an embodiment, the output comprises one or more actions to be performed by the device. At 505, based upon the generated output, remedial action(s) may be taken to improve device performance and the output is sent to a server for further data storage and analysis. In an embodiment, the device stores the generated output locally within the device. In an embodiment, based upon the output, the device controls actuations of one or more actuators and initiates or triggers a workflow for starting one or more repair actions for the device.

Embodiments provide intelligent IoT devices which can filter and process data, e.g., based upon predefined rules. The rules may be easily defined or configured for any IoT device through user-friendly UIs (e.g., the UIs in tabular format receiving users' input). Therefore, the users are not required to be skilled of hardcoding the rules or constraints within the application rather the rules can be easily entered or configured as input/entry through UIs. The UIs are centrally hosted (e.g., on cloud) and can be accessed from anywhere, e.g., by an authenticated user. The configured rules or constraints can be easily pushed or deployed to the selected one or more IoT devices. Different rules may be configured for different IoT devices. Based upon the rules or constraints, data can be analyzed, processed, and filtered at the IoT device itself. The filtered data excludes the undesired data or noise. The filtered data can then be sent or transferred to the cloud/server. Therefore, the cloud or server receives only the desired or required data which saves memory, storage, and reduces cost along with increasing speed or efficiency. Further, as the data can be filtered and/or stored at the IoT device itself, the system can perform data processing and analysis in real time even if there is internet connectivity issues and/or server issues. The analysis or evaluation of event is more in real time and therefore, predictive maintenance and analysis can be performed effectively on time. For example, the remedial action (e.g., starting the repair work flow) may be triggered instantaneously in real time or at right time at the device itself which avoids accidents, etc. Therefore, there is no dependencies on overloaded server or there is no latency in data analysis or processing. The business decisions may be taken in real time, e.g., locally at the device itself

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” includes a single medium or multiple media that stores one or more sets of instructions. The term “computer readable storage medium” includes physical article that is capable of undergoing a set of physical changes to physically store, encode, or otherwise carry a set of instructions for execution by a computer system which causes the computer system to perform the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

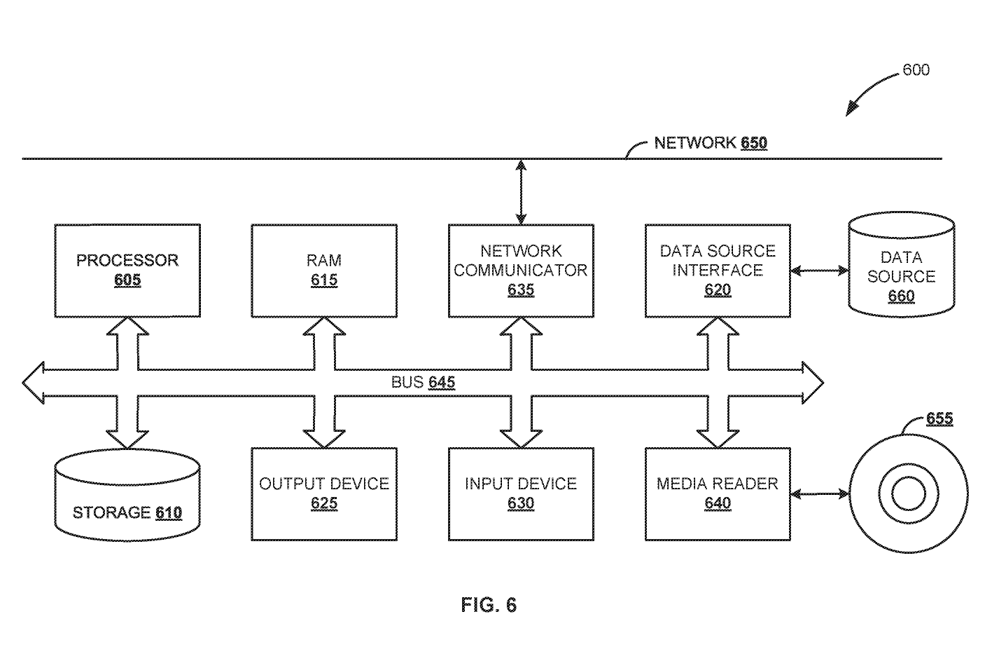

FIG. 6 is a block diagram of an exemplary computer system 600. The computer system 600 includes a processor 605 that executes software instructions or code stored on a computer readable storage medium 655 to perform the above-illustrated methods. The processor 605 can include a plurality of cores. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. According to some embodiments, such as some in-memory computing system embodiments, the RAM 615 can have sufficient storage capacity to store much of the data required for processing in the RAM 615 instead of in the storage 610. In some embodiments, the data required for processing may be stored in the RAM 615. The stored instructions may be further compiled to generate other representations of the instructions and dynamically stored in the RAM 615. The processor 605 reads instructions from the RAM 615 and performs actions as instructed. According to one embodiment, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. The output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an enterprise resource planning (ERP) system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments is to be determined by the following claims, which are to be interpreted in accordance with established doctrines of claim construction.

What is claimed is:

1. An internet of things (IoT) device, comprising:
a controller configured to:
read data collected in real time by one or more sensors, wherein the data comprises values of a plurality of parameters related to the IoT device;
correlate the collected data of the plurality of parameters;
identify one or more predefined events;
based upon the identified one or more predefined events, filter the correlated data to generate an output;
based upon the generated output, perform at least one of:
controlling actuations of one or more actuators; and
initiating a workflow to trigger one or more repair actions; a rule engine configured to:
invoke the controller to identify the one or more predefined events and filter the correlated data to generate output;
and
a local storage communicatively coupled to the controller and configured to store the generated output.

2. The IoT device of claim 1, wherein the data is collected by one or more sensors coupled to the IoT device.

3. The IoT device of claim 1, wherein the data of the plurality of parameters is correlated based on time and the correlated data includes a time stamp indicating the point of time the data is collected.

4. The IoT device of claim 1, wherein correlating the collected data comprises storing together the data of different parameters collected in same point of time.

5. IoT device of claim 1, wherein the controller is further configured to:
determine whether at least one of the correlated data satisfies the one or more predefined events; and
upon determining that the at least one of the correlated data satisfies the one or more predefined events, generate the output including the at least one correlated data which satisfied the one or more predefined events.

6. The IoT device of claim 1, wherein the controller is further configured to:
receive a request for deploying one or more events within the IoT device;
authenticate a server from where the request is received;
upon successful authentication of the server, deploy the one or more events within the IoT device; and
upon unsuccessful authentication, send an error message to the server.

7. The IoT device of claim 1, wherein the controller is further configured to:
determine whether the IoT device is connected to a server;
when the IoT device is connected to the server, send the generated output to the server; and
when the IoT device is not connected to the server, send the generated output to the local storage.

8. The IoT device of claim 1, wherein an actuator of the one or more actuators comprises one of an alarm and a light and wherein controlling actuation of the alarm comprises switching ON the alarm and controlling actuation of the light comprises switching ON or switching OFF the light.

9. The IoT device of claim 1, wherein a parameter of the plurality of parameters includes one of a temperature, a vibration, a moisture content, a pressure, and a speed.

10. A computer-implemented method for filtering and processing data related to internet of things, the method comprising:
reading data collected in real time by one or more sensors coupled to an internet of things (IoT) device;
at the IoT device, correlating the read data;
identifying one or more predefined events;
determine, at the IoT device, whether at least one of the correlated data satisfies the one or more predefined events;
upon determining that the at least one of the correlated data satisfies the one or more predefined events, generating an output including the at least one correlated data which satisfied the one or more predefined events;
and
based upon the generated output, performing at least one of:
controlling actuations of one or more actuators; and
initiating a workflow to trigger one or more repair actions.

11. The computer-implemented method of claim 10 further comprising:
determining whether the IoT device is connected to a server;
when the IoT device is connected to the server, sending the generated output to the server; and
when the IoT device is not connected to the server, sending the generated output to a local storage of the IoT device.

12. A non-transitory computer-readable medium to store instructions, which when executed by a computer, causes the computer to:
read data collected in a real time by one or more sensors coupled to an internet of things (IoT) device;
correlate the read data;
identify the one or more predefined events;
determine whether at least one of the correlated data satisfies the one or more predefined events;
upon determining that the at least one of the correlated data satisfies the one or more predefined events, generate an output;
and
based upon the generated output, perform at least one of:
controlling actuations of one or more actuators; and
initiating a workflow to trigger one or more repair actions for the IoT device.

13. The computer-readable medium of claim 12, wherein the data refers to values of one or more parameters of the IoT device and wherein a parameter of the one or more parameters includes one of a temperature, a vibration, a moisture content, a pressure, and a speed of the IoT device.

14. The computer-readable medium of claim 12, wherein the data is read continuously or at a predefined time interval.

15. The computer-readable medium of claim 12, wherein correlating the read data comprises storing together the data of different parameters collected in same point of time and the correlated data further includes a time stamp indicating the point of time the data is collected.

16. The computer-readable medium of claim 12 wherein the non-transitory computer readable medium further include instructions to:
receive a request for deploying one or more events within the IoT device;
authenticate a server from where the request is received;
upon successful authentication of the server, deploy the one or more events within the IoT device;
upon unsuccessful authentication, send an error message to the server;
determine whether the IoT device is connected to the server;
when the IoT device is connected to the server, send the generated output to the server; and
when the IoT device is not connected to the server, send the generated output to a local storage of the IoT device.

17. The computer-readable medium of claim 12, wherein the output further comprises an identifier of the IoT device and a time stamp indicating a time at which the one or more predefined events occurred.

18. A system for filtering and processing data related to interact of things, the system comprising:
at least one internet of things (IoT) device comprising:
a controller configured to:
read data collected in real time by one or more sensors, wherein the data comprises values of a plurality of parameters related to the IoT device;
correlate the collected data of the plurality of parameters;
identify one or more predefined events; and
based upon the identified one or more predefined events, filter the correlated data to generate output;
a rule engine configured to invoke the controller to identify the one or more predefined events and filter the correlated data to generate output;
and
a local storage communicatively coupled to the controller and configured to store the generated output;
and
a server communicatively coupled to the at least one IoT device and configured to receive output from the at least one IoT device and performs analysis on the received output.

19. The system of claim 18, wherein the controller is further configured to:
send the generated output to the local storage;
upon determining successful connection with the server, send the generated output to the server;
control actuations of one or more actuators; and
initiate a workflow for starting one or more repair actions for the IoT device.

20. The system of claim 18, wherein the server includes an application comprising one or more user interfaces in tabular format for configuring one or more events and wherein the server is further configured to:
upon successful authentication of a user, allow the user to configure the one or more events through the one or more user interfaces; and
deploy the configured one or more events in the at least one IoT device.
